(19) United States
(12) Patent Application Publication
(10) Pub. No.: US 2003/0131258 A1
(43) Pub. Date: Jul. 10, 2003

(54) Peer-to-peer communication across firewall using internal contact point

(76) Inventor: Seemab Aslam Kadri, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/038,341

(22) Filed: Jan. 4, 2002

(51) Int. Cl. H04L 9/00

(52) U.S. Cl. 713/201

(57) ABSTRACT

In one embodiment of the invention, an internal contact point includes a gateway interface, a collector, a registrar, and a distributor. The gateway interface interfaces internally to a firewall to a gateway device located at the firewall. The collector collects a message intended for an internal peer inside the firewall. The message is transmitted by an external peer outside the firewall. The registrar registers the internal peer for external communication across the firewall. The distributor distributes the message to the internal peer.

### BACKGROUND

1. Field of the Invention

This invention relates to networks, and more particularly to communication across firewalls.

2. Description of Related Art

Firewalls and Network Address Translation (NAT) are techniques that provide secure connectivity of a group of computers or devices on a private network to a group of devices or computers on other public or private networks such as the Internet. Firewalls and NAT allow requests to be made from inside to outside of a network, but they block request initiation from the outside. The problem is that peers inside the firewall cannot be contacted or queried.

In particular, firewall and NAT devices provide protection by blocking communication from non-standard ports and masquerading Internet Protocol (IP) addresses of the devices behind them. With port blocking, only devices on the inside are allowed to initiate a query to devices outside and only on standard ports. IP masquerading hides the true IP addresses of the devices inside, thereby keeping them anonymous to outside.

Existing techniques to allow outside devices to communicate with inside devices through firewalls have a number of disadvantages. Typically, to use non-standard ports and allow incoming traffic, tunneling is used. In tunneling, a standard open port, such as the Hypertext Transfer Protocol (HTTP), is used. The non-standard packet is wrapped in an HTTP shell and passed through the firewall as a request and response. To work around IP masquerading, a relay server outside the firewall is used as a contact point for inside peers to the outside world. Peers inside the firewall have to maintain a continuously polled connection to the relay server. When the number of peers inside the firewall wanting to connect to the relay server increases, the required bandwidth also increases, thereby causing traffic problems and resources to the relay server. In addition, due to the continuous polling, the inside peer devices may hold up individual connections for a long time even though they are not doing any useful communication to the outside world, thereby causing wasteful redundancy.

Therefore, there is a need to have an efficient technique to provide communication across firewalls.

### BRIEF DESCRIPTION OF THE DRAWINGS

The features and advantages of the present invention will become apparent from the following detailed description of the present invention in which:

FIG. 1 is an exemplary diagram illustrating a system 100 in which one embodiment of the invention can be practiced;

FIG. 2 is an exemplary diagram illustrating an internal contact point shown in FIG. 1 according to one embodiment of the invention; and

FIG. 3 is an exemplary flowchart illustrating a process for communication across firewall according to another embodiment of the invention.

### DESCRIPTION OF THE INVENTION

The invention is a technique to allow efficient communication across firewalls. In one embodiment, an internal contact point located inside the firewall is used as contact point for the inside peers. The internal contact point establishes a continuous connection to the outside relay server through tunneling.

One embodiment of the internal contact point may include a collector and a distributor. The collector collects a message intended for an internal peer inside a firewall via a gateway device at the firewall. The message may be transmitted by an external peer outside the firewall. The distributor then distributes the message to the internal peer. The internal contact point may also include a registrar to register the internal peer for external communication across the firewall. In addition, the internal contact point may include a gateway interface that interfaces internally to a firewall or to the gateway device located at the firewall.

The invention offers at least the following advantages. First, since the internal contact point, and not all internal peer devices, forms a connection to the outside relay server, bandwidth and redundant connections are significantly reduced. Second, if static Network Address Translation (NAT) is used, then one fixed address can be used, leading to savings in the NAT bandwidth. Third, there may be a single point of security check for threat.

In the following description, for purposes of explanation, numerous details are set forth in order to provide a thorough understanding of the present invention. However, it will be apparent to one skilled in the art that these specific details are not required in order to practice the present invention. In other instances, well-known structures are shown in block diagram form in order not to obscure the present invention.

The present invention may be implemented by hardware, software, firmware, microcode, or any combination thereof. When implemented in software, firmware, or microcode, the elements of the present invention are the program code or code segments to perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a read-only memory (ROM), a flash memory, an erasable ROM (EROM), a floppy diskette, a compact disk ROM (CD-ROM), an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

Also, it is noted that the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

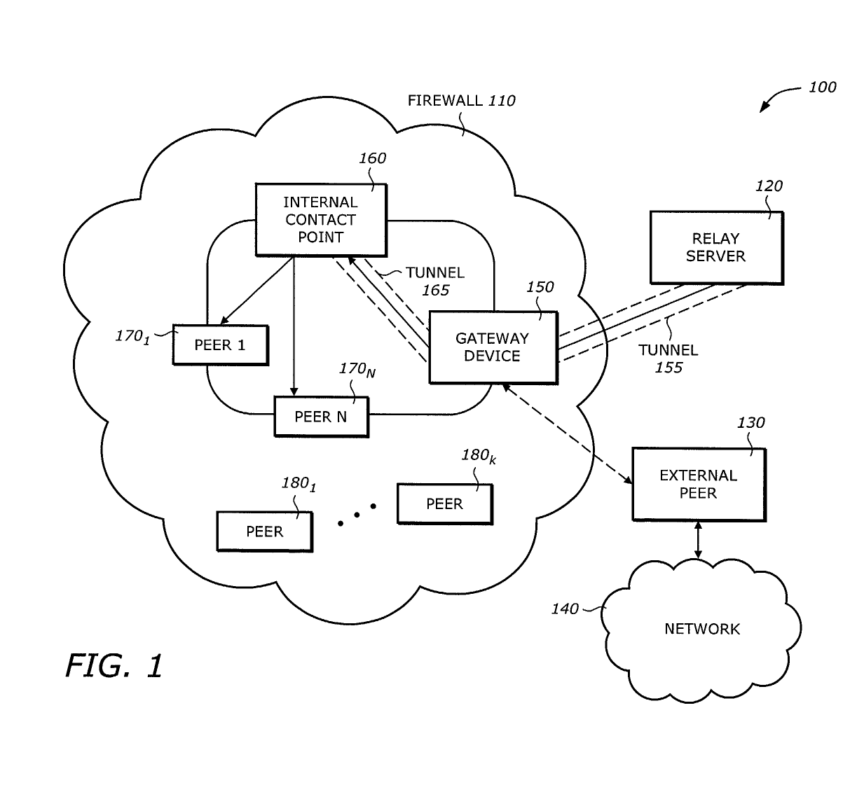

FIG. 1 is an exemplary diagram illustrating a system 100 in which one embodiment of the invention can be practiced. The system 100 includes a firewall 110, a relay server 120, an external peer 130, and a network 140.

Generally, the firewall 110 protects a network of devices or computers from intentional hostile intrusion that could compromise confidentiality or result in data corruption or denial of service. It may be a hardware device or a software program running on a secure host computer, or a combination of hardware and software. In the example, the firewall 110 includes a gateway device 150, an internal contact point 160, N registered internal peers 170₁ to 170_{N}, and K unregistered internal peers 180₁ to 180_{K}.

The gateway device 150 is located at the firewall boundary between the protected internal network and the external world. The gateway device 150 may be any one of the four types: a packet filter, a circuit level gateway, an application level gateway and a stateful multilayer inspection firewall.

Packet filtering firewalls work at the network level of the Open Systems Interconnection (OSI) model, or the Internet Protocol (IP) layer of Transmission Control Protocol/IP (TCP/IP). They are usually parts of a router. In a packet filtering firewall, each packet is compared to a set of criteria before it is forwarded. Depending on the packet and the criteria, the gateway device 150 can drop the packet, forward it or send a message to the originator. Rules can include source and destination IP address, source and destination port number and the protocol used. However, this type of firewall mainly works at the network layer and does not support sophisticated rule based models. NAT routers offer the advantages of packet filtering firewalls, but can also hide the IP addresses of computers behind the firewall and offer a level of circuit-based filtering.

Circuit level gateways work at the session layer of the OSI model, or the TCP layer of TCP/IP. They monitor TCP handshaking between packets to determine whether a requested session is legitimate. Information passed to a remote computer through a circuit level gateway appears to have originated from the gateway. This is useful for hiding information about protected networks. Circuit level gateways are relatively inexpensive and have the advantage of hiding the information about the private network they protect. On the other hand, they do not filter individual packets.

Application level gateways, also called proxies, are similar to circuit-level gateways except that they are application specific. They can filter packets at the application layer of the OSI model. Incoming or outgoing packets cannot access services for which there is no proxy. An application level gateway that is configured to be a web proxy will not allow any File Transfer Protocol (FTP), gopher, telnet or other traffic through. Because they examine packets at the application layer, they can filter application specific commands such as hypertext protocol (http):post and get, etc. Application level gateways can also be used to log user activity and logins. They offer a high level of security, but have a significant impact on network performance. This is because of context switches that dramatically slow down network access. They are not transparent to end users and require manual configuration of each client computer.

Stateful multilayer inspection firewalls combine the aspects of the other three types of firewalls. They filter packets at the network layer, determine whether session packets are legitimate and evaluate contents of packets at the application layer. They allow direct connection between client and host, alleviating the problem caused by the lack of transparency of application level gateways. They rely on algorithms to recognize and process application layer data instead of running application specific proxies. Stateful multilayer inspection firewalls offer a high level of security, good performance and transparency to end users.

The technique described in the invention may work with any gateway devices including the gateway devices described above. It is also noted that although the term “device” is used, it may refer to a physical device, an equipment, a computer, a software program, a program module, or any combination of hardware and software.

Referring back to FIG. 1, the internal contact point 160 is the central contact point for the peers 170₁ to 170_{N} inside the firewall 110. The internal contact point 160 communicates with the gateway device 150 via a tunnel 165. Thus, the internal contact point 160 communicates to the relay server 120 or the external peer 130 via the gateway device 150, and forwards the information or messages received from the external peer 130 and other external peers to the registered internal peers. The internal connect point 160 may be implemented by hardware, software, or any combination of hardware and software. The internal contact point 160 may have interface to mass storage device to access processor readable medium (e.g., CD-ROM, floppy diskette, or hard drive) containing a program or function implementing any one of the techniques in this invention.

The registered internal peers 170₁ to 170_{N} are devices, equipment, or computers located inside the firewall 110. The internal peers 170₁ to 170_{N} register to the internal contact point 160 to appoint the internal contact point 160 to be their contact point for external communication with devices outside the firewall 110 such as the external peer 130. The internal peers 170₁ to 170_{N} may send messages to the outside world such as the external peer 130 directly via the gateway device 150 or via the internal contact point 160. The internal peers 170₁ to 170_{N}, however, receive the messages sent from external devices such as the external peer 130 from the internal contact point 160 only.

The unregistered internal peers 180₁ to 180_{K} are devices, equipment, or computers located inside the firewall 110 but do not participate in the external communication to the outside world. They remain protected by the firewall 110 and cannot receive messages sent from the external peer 130

The relay server 120 is a server that has a tunnel 155 to the gateway device 150. The relay server 120 may contain software to provide cross-firewall interaction. The relay server 120 has interfaces to a number of external peers including the external peer 130 that want to communicate with the internal peers 170₁ to 170_{N}. The relay server 120 may not be needed when the external devices may have direction connection to the firewall 110 via the gateway device 150. This is typically the case when the gateway device 150 uses a static NAT.

The external peer 130 is any device, equipment, or computer that is located outside the firewall 110 and has a connection directly to the gateway device 150 or through the relay server 120. The external peer 130 is connected to the network 140. The external peer 130 wishes to communicate with at least one of the internal peers. The network 140 is any network of devices, equipment, or computers having networking functionalities. The network 140 may be any one of a local area network (LAN), a wide area network (WAN), an intranet, an extranet, or an Internet.

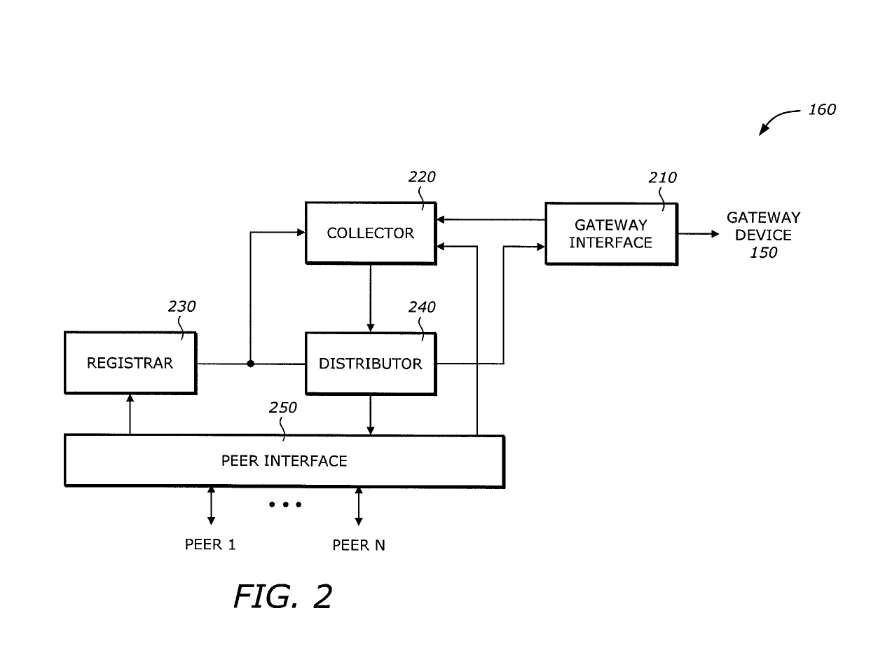

FIG. 2 is an exemplary diagram illustrating the internal contact point 160 shown in FIG. 1 according to one embodiment of the invention. In the example, the internal contact point 160 includes a gateway interface 210, a collector 220, a registrar 230, a distributor 240, and a peer interface 250. However, note that the internal contact point 160 may be implemented including more or less than the above components, and by a combination of two or more components. Also, any one of the gateway interface 210, the collector 220, the registrar 230, the distributor 240, and the peer interface 250 may be implemented by hardware, software, a program, a module, a microcode routine, a function, or any combination thereof

The gateway interface 210 interfaces internally to the firewall 110 to the gateway device 150 located at the firewall 110. When required, the gateway interface 210 establishes a continuous connection to the relay server 120 outside the firewall 110 through tunneling. The gateway interface 210 is also responsible for forwarding the registration information of the registered internal peers 170₁ to 170_{N} to the relay server 120 such that the relay server 120 is notified that these internal peers are now represented by the internal contact point 160.

The collector 220 collects messages sent by the outside world such as the external peer 130. The messages are intended for any one of the internal peers 170₁ to 170_{N}. The collector 220 may also collect messages sent by the internal peers 170₁ to 170_{N} when the internal peers 170₁ to 170_{N} want to send messages via the internal contact point 160 rather than directly to the gateway device 150.

The registrar 230 registers the internal peer wishing to establish a communication to the external world across the firewall 110. The registrar 230 compiles a list of the internal peers 170₁ to 170_{N} inside the firewall 110 wishing to receive messages from the external peer 130. The addresses of these registered internal peers 170₁ to 170_{N} will be compared with the destination address information received by the collector 220 such that a decision to forward or distribute the message can be made.

The distributor 240 distributes the collected message to the internal peer recipient if there is a match in the address information of the message and the registered peer. The distributor 240 receives the registration information forwarded by the registrar 230 and maintains a list of registered internal peers. When the collector 240 forwards messages to the distributor 240, the distributor 240 compares the address information with that of the registered internal peers. If there is no address match, either because there is no corresponding peer or the peer has not been registered, the message will be rejected or discarded. The distributor 240 may also connect to the gateway interface 210 rather than directly to the gateway device 150, when the registered internal peer wishes to send a message to the outside world.

The peer interface 250 interfaces to the internal peers 170₁ to 170_{N} for distributing the message or messages. The peer interface 250 also receives registration information from the internal peers 170₁ to 170_{N} and passes the registration information to the registrar 230 to establish a list of registered internal peers. In addition, when the internal peers 170₁ to 170_{N} want to send messages to the outside world via the internal contact point 160, the peer interface 250 receives the messages sent by any one of the internal peers 170₁ to 170_{N} and forwards the messages to the collector 220.

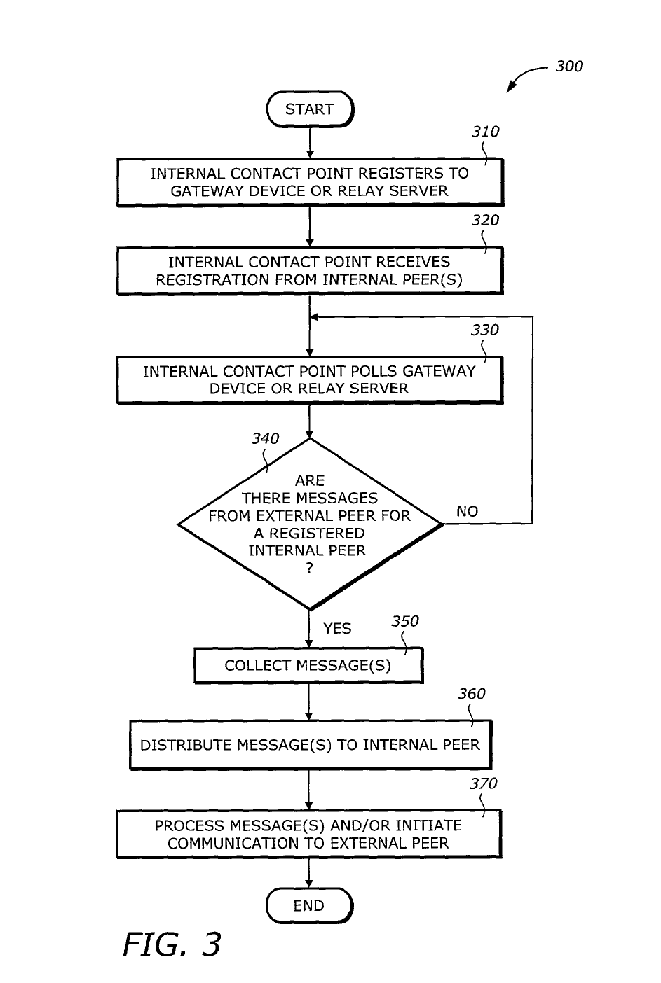

FIG. 3 is an exemplary flowchart illustrating a process 300 for communication across the firewall according to another embodiment of the invention.

Upon START, the process 300 registers the internal contact point to the gateway device at the boundary of the firewall or to the relay server outside the firewall (Block 310). This registration allows the external relay server to act as the contact point for the internal contact point to the outside world. Then, the process 300 receives registration from the internal peers wishing to have communication to the external peer 130 (Block 320). Upon registration, the internal contact point will acts as the intermediary to receive messages from the external peer 130 and distributes to the proper internal peer recipient.

Next, the process 300 polls the gateway device or the relay server to check for any incoming message for the registered internal peers using a single connection (Block 330). An external peer that wishes to contact an internal peer A typically uses some name-service to figure out that the relay server is the contact point of the internal contact point which in turn the contact point for the internal peer A. The external peer therefore sends a message intended for the internal peer A to the relay server. Then, the process 300 determines if there is any message from the external peer intended for an internal registered peer (Block 340). If not, the process 300 returns back to block 330 to continue polling the gateway device or the relay server. Otherwise, the process 300 collects the message(s) and organize the message(s) for distribution (Block 350).

Then, the process 300 distributes the message(s) to the registered internal peers according to the addresses in the messages (Block 360). Since the peers are not continuously polling the gateway device or the relay server, significant reduction of redundant connections and bandwidth can be achieved. Next, the process 300 processes the message and/or initiates communication to the external peer, either directly or indirectly via a relay if the external peer is behind a firewall itself (Block 370).

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention. For example, although the invention has been described with reference to a separate internal contact point, the internal contact point may implemented in other ways.

While implementing the internal contact point separately requires no changes in the existing networking environment, the internal contact point may also be placed in the De-Militarized Zone (DMZ) of the firewall, making it more secure. In addition, the internal contact point may be combined with the firewall device. This combination can efficiently utilize the firewall's scanning ability and parse the packets coming in for threats. In still other alternative embodiments, the internal contact point, the firewall device and the relay server can be combined into a single device. This will make the device a single point of contact for registered peers into the network. For example, if NAT is configured in a way that the internal contact point has a fixed outside address, i.e. “IP<:Port> using techniques such as static NAT, then there would be no need of a relay server.

Furthermore, note that a single internal contact point is sufficient behind every NAT or firewall for a whole network. Also, since the internal contact point is the one point of entry for the incoming requests, extensive message content checks can be performed here to ensure security. Moreover, the presence of the internal contact point can significantly increase the efficiency of communication. In the existing technology, two peers that use a relay server typically go through the relay server even if they are on the same network. This is because from the relay server, there is no reliable way for the peers to figure out that they can communicate directly. An internal contact point, on the other hand, can figure out which peer is trying to reach which and determine if the peers can communicate directly, thereby saving a great amount of bandwidth.

Therefore, the invention allows an efficient communication across firewalls and networks.

What is claimed is:

1. An apparatus comprising:
a collector to collect a message intended for an internal peer inside a firewall via a gateway device at the firewall, the message being transmitted by an external peer outside the firewall; and
a distributor coupled to the collector to distribute the message to the internal peer.

2. The apparatus of claim 1, further comprising:
a gateway interface to interface internally to the firewall to the gateway device.

3. The apparatus of claim 2, wherein the gateway interface establishes a continuous connection to a relay server outside the firewall through tunneling.

4. The apparatus of claim 3, wherein the collector registers to the relay server to act as an external contact point for the external peer.

5. The apparatus of claim 4, further comprising a registrar to register the internal peer for external communication across the firewall, and wherein the collector polls the relay server for an incoming message for a registered internal peer using a single connection.

6. The apparatus of claim 1, wherein the gateway device is one of a firewall and a network translation address (NAT) device.

7. The apparatus of claim 1, further comprising:
a registrar to register the internal peer for external communication across the firewall.

8. The apparatus of claim 7, wherein the collector polls the gateway device for an incoming message for a registered internal peer using a single connection.

9. The apparatus of claim 7, wherein the collector collects an internal message from a registered internal peer to be transmitted to the external peer.

10. The apparatus of claim 9, wherein the distributor distributes the collected internal message to the external peer via the gateway device.

11. A method comprising:
collecting a message intended for an internal peer inside a firewall via a gateway device at the firewall, the message being transmitted by an external peer outside the firewall; and
distributing the message to the internal peer.

12. The method of claim 11, further comprising:
interfacing internally to the firewall to the gateway device located at the firewall.

13. The method of claim 12, wherein the interfacing comprises: establishing a continuous connection to a relay server outside the firewall through tunneling.

14. The method of claim 13, wherein the collecting comprises: registering to the relay server to act as an external contact point for the external peer.

15. The method of claim 14, further comprising registering the internal peer for external communication across the firewall, and polling the relay server for an incoming message for a registered internal peer using a single connection.

16. The method of claim 11, wherein the interfacing to the gateway device comprises: interfacing to one of a firewall and a network translation address (NAT) device.

17. The method of claim 11, further comprising:
registering the internal peer for external communication across the firewall.

18. The method of claim 17, wherein the collecting comprises: polling the gateway device for an incoming message for a registered internal peer using a single connection.

19. The method of claim 17, wherein the collecting comprises: collecting an internal message from a registered internal peer to be transmitted to the external peer.

20. The method of claim 19, wherein the distributing comprises: distributing the collected internal message to the external peer via the gateway device.

21. A system comprising:
a gateway device located at a firewall; and
an internal contact point located inside the firewall, the internal contact point comprising:
a collector to collect a message intended for an internal peer inside a firewall via a gateway device at the firewall, the message being transmitted by an external peer outside the firewall; and
a distributor coupled to the collector to distribute the message to the internal peer.

22. The system of claim 21, further comprising:
a gateway interface to interface internally to the firewall to the gateway device.

23. The system of claim 22, wherein the gateway interface establishes a continuous connection to a relay server outside the firewall through tunneling.

24. The system of claim 23, wherein the collector registers to the relay server to act as an external contact point for the external peer.

25. The system of claim 24, further comprising a registrar to register the internal peer for external communication across the firewall, and wherein the collector polls the relay server for an incoming message for a registered internal peer using a single connection.

26. The system of claim 21, wherein the gateway device is one of a firewall and a network translation address (NAT) device.

27. The system of claim 21, further comprising:
a registrar to register the internal peer for external communication across the firewall.

28. The system of claim 27, wherein the collector polls the gateway device for an incoming message for a registered internal peer using a single connection.

29. The system of claim 27, wherein the collector collects an internal message from a registered internal peer to be transmitted to the external peer.

30. The system of claim 29, wherein the distributor distributes the collected internal message to the external peer via the gateway device.

31. A gateway device comprising:
an internal contact point located inside the firewall, the internal contact point comprising:
a collector to collect a message intended for an internal peer inside a firewall via a gateway device at the firewall, the message being transmitted by an external peer outside the firewall; and
a distributor coupled to the collector to distribute the message to the internal peer.

32. The system of claim 31, further comprising:
a gateway interface to interface internally to the firewall to the gateway device.

33. The system of claim 31, wherein the gateway device is one of a firewall and a network translation address (NAT) device.

34. The system of claim 31, further comprising:
a registrar to register the internal peer for external communication across the firewall.

35. The system of claim 31, further comprising: a relay server to interface to a number of external peers outside the firewall.
